(19) United States
(12) Patent Application Publication
(10) Pub. No.: US 2023/0062264 A1
(43) Pub. Date: Mar. 2, 2023

(54) CARBON DIOXIDE SEQUESTRATION USING NANOPARTICLES

(71) Applicant: CERIUM LABORATORIES LLC, Austin, TX (US)

(72) Inventors: Timothy Hossain, Austin, TX (US); Clayton Fullwood, Austin, TX (US)

(21) Appl. No.: 17/899,418

(22) Filed: Aug. 30, 2022

Related U.S. Application Data
(60) Provisional application No. 63/238,639, filed on Aug. 30, 2021.

(51) Int. Cl. B01J 20/04; B01J 20/28; B01J 20/34; B01D 53/96; B01D 53/62; B01D 53/82; B01D 53/83

(52) U.S. Cl. CPC B01J 20/041; B01J 20/28007; B01J 20/28016; B01J 20/28059; B01J 20/28061; B01J 20/3483; B01J 20/3433; B01J 20/3441; B01D 53/96; B01D 53/62; B01D 53/82; B01D 53/83; B01D 2251/302; B01D 2251/602; B01D 2257/504

(57) ABSTRACT

A system for capturing and sequestering carbon dioxide includes nanoparticles formed from alkali or alkali metal oxides or hydroxides, such as lithium oxide. Carbon-dioxide containing effluent gasses are exposed to the nanoparticles in fixed beds or fluidized beds, or in a co-flow configuration. The nanoparticle metal oxides are converted to metal carbonates. The nanoparticles can be recovered and the carbon dioxide release by exposing the nanoparticles to an oxygen containing atmosphere at high temperatures.

### CROSS-REFERENCE TO RELATED APPLICATION(S)

This application claims benefit of U.S. Provisional Application No. 63/238,639, filed Aug. 30, 2021, which is incorporated herein by reference in its entirety.

### FIELD OF THE DISCLOSURE

This disclosure, in general, relates to the use of nanoparticles for carbon dioxide capture and sequestration

### BACKGROUND

With growing concern over the contribution of carbon dioxide to climate change, industry is under increasing pressure to capture and sequester carbon dioxide from the effluent streams. The global community is committed to a goal of zero net carbon production by 2050. To meet this goal, industries are being incentivized to develop technologies to reduce carbon dioxide production, capture carbon dioxide, and sequester carbon dioxide.

A number of solvent extraction and cryogenic techniques have been developed. However, extraction techniques consume a significant amount of energy and reagents, making them costly. Cryogenic techniques require cooling to extremely low temperatures, which are costly and energy intensive processes.

Once captured, the carbon dioxide can be sequestered in underground geological structures. Oftentimes, carbon dioxide is injected into aging oil fields for enhanced oil recovery. In another example, the captured carbon dioxide can be utilized in greenhouses and other indoor agricultural applications.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an example process for capturing and sequestering carbon dioxide from waste streams.

FIG. 2, FIG. 3, and FIG. 4 include illustrations of example systems for capturing carbon dioxide from effluent streams.

FIG. 5 and FIG. 6 illustrate an experimental system for collecting CO₂ from an effluent stream.

The use of the same reference symbols in different drawings indicates similar or identical items.

### DETAILED DESCRIPTION

In an example embodiment, a carbon dioxide-containing effluent stream is exposed to nanoparticles including alkali or alkali metal oxides or hydroxides, such as lithium oxide or lithium hydroxide. The nanoparticles have a size in a range of 10 nm to 1000 nm, and a specific surface area in a range of 5 m²/g to 100 m²/g. The nanoparticles can be secured in a fixed bed or fluidized bed and exposed to an effluent stream containing carbon dioxide. In another example, the nanoparticles can flow in a co-flow configuration and be separated from the effluent stream using a filter or vortex separator. In response to being exposed to carbon dioxide, the alkali or alkali earth metal oxides, such as lithium oxide, can undergo chemical changes to form carbonates. Once separated from the effluent stream, the nanoparticles can be recovered and converted back to oxides, for example, by exposing the particles to a high temperature oxygenated environment.

In an example, the present system relies on the use of nanoparticles comprising alkali or alkaline earth metal oxides or hydroxides. For example, the nanoparticles can include lithium oxide or lithium hydroxide, which react with carbon dioxide to form lithium carbonate. The carbon dioxide can be released, and the lithium oxide or hydroxide recovered by exposing the nanoparticles to high temperature (e.g. 400° C. to 900° C.) and an oxygen-containing environment.

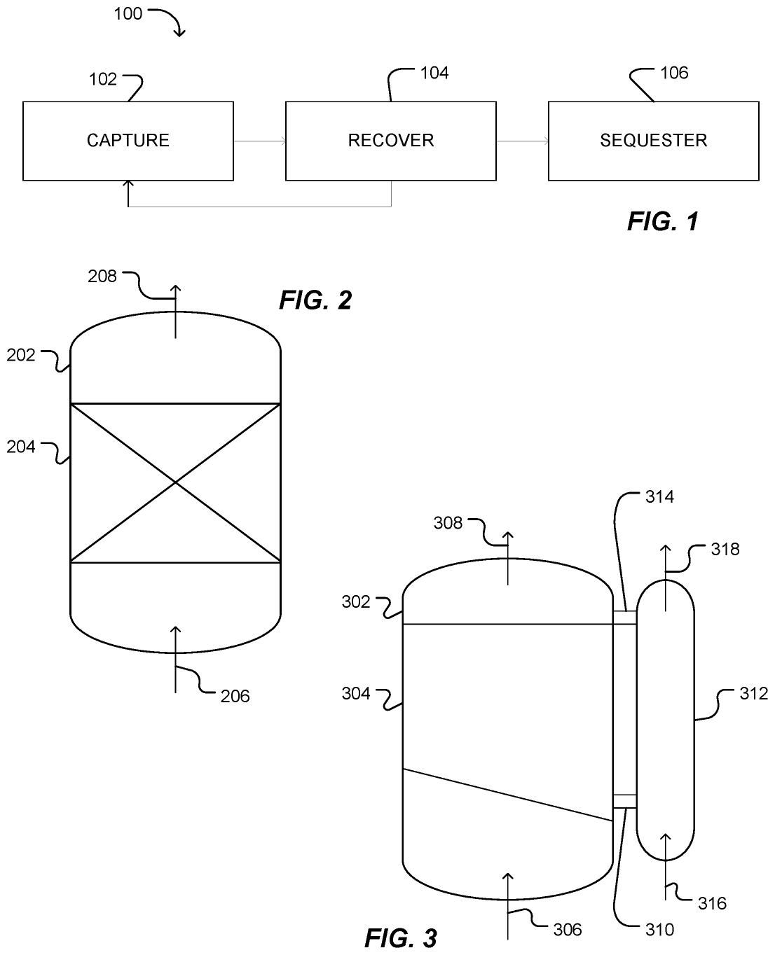

For example, FIG. 1 illustrates an example method for capturing and sequestering carbon dioxide. As illustrated at block 102, carbon dioxide from an effluent stream is captured. For example, alkali or alkali earth metal oxides or hydroxides are used in the form of nanoparticles to capture carbon dioxide from the gaseous effluent stream. In an example, lithium oxide nanoparticles can be at least partially converted to lithium carbonate when exposed to the carbon dioxide containing effluent stream. In an example, Li₂O nanoparticles provide enhanced surface reactions leading to efficient capture and formation of Li₂CO₃.

The capturing can be performed at a temperature in a range of 25° C. to 600° C. For example, the temperature can be in a range of 25° C. to 400° C., such as a range of 25° C. to 250° C. or a range of 25° C. to 100° C.

The stream applied to the nanoparticles can have carbon dioxide in a concentration of 0.5% to 80% by weight. For example, the stream can be 0.5% to 50% carbon dioxide, such as 0.5% to 25% or 0.5% to 18%. After capture, the stream can include carbon dioxide in a range of 0.01% to 5.0%. For example, after capture, the stream can have 0.01% to 2.0% carbon dioxide, such as 0.01% to 1.0% carbon dioxide or 0.05% to 0.5% carbon dioxide. The concentration of carbon dioxide in the stream is reduced at least 50%, such as at least 80%. For example, the carbon dioxide is reduced in a range of 60% to 99.9%, such as a range of 75% to 99% or 80% to 95%.

Carbon dioxide can be separated from the metal oxide nanoparticles, allowing for recovery of the nanoparticles to be recycled to carbon dioxide capture, as illustrated at block 104. For example, the nanoparticles including the metal carbonate can be exposed to an oxygen-containing environment at higher temperature facilitating the release of carbon dioxide and the conversion of the metal carbonate to a metal oxide. The higher temperature can be in a range of 400° C. to 900° C. For example, the higher temperature can be in a range of 500° C. to 800° C., such as a range of 600° C. to 700° C. Alternatively or in addition, a voltage potential can be applied across the nanoparticles. For example, the voltage potential can be in a range of 3V to 100V, such as a range of 3V to 50V or a range of 3V to 10V. Metal oxide containing nanoparticles can then be recycled to capture carbon dioxide, as illustrated at block 102.

The carbon dioxide released from the nanoparticles can be sequestered, as illustrated at 106. For example, carbon dioxide can be compressed and injected in underground geological structures. In another example, carbon dioxide can be utilized in greenhouses or indoor hydroponic gardens to facilitate growth of vegetation.

In an example, the nanoparticles include alkali or alkali earth metal oxides or hydroxides. For example, the alkali or alkali earth metal can include lithium, sodium, potassium, magnesium, calcium, barium, cesium, or a combination thereof. In a particular example, the nanoparticles include an oxide or hydroxide of alkali metals, such as an oxide or hydroxide of lithium, sodium, or potassium. For example, the nanoparticles can include lithium oxide or lithium hydroxide. In particular, the nanoparticles include lithium oxide.

The nanoparticles can have a consistent composition throughout. In another example, the nanoparticles can have a core-shell configuration. For example, the core can be formed of silicon, silicon carbide, silicon dioxide, alumina, aluminosilicate, ceria, titania, or lithium silicide. The core can be covered by a shell of alkali or alkali earth metal oxide or hydroxide. In an example, a silicon dioxide or silicon carbide core can be coated with lithium oxide. In another example, a lithium silicide core can be coated with a lithium oxide shell. In a further example, a silica, aluminosilicate, or lithium core can have lithium oxide particles attached to the surface. In a particular example, the nanoparticles are free of a metal catalyst, e.g., free of lanthanide or actinide metals or metal oxides.

The nanoparticles can have an average size in a range of 10 nm to 1000 nm. For example, the average size can be in a range of 10 nm to 500 nm, such as a range of 10 nm to 100 nm or a range of 15 nm to 45 nm. In a further example, the nanoparticles can have a specific surface area in a range of 5 m²/g to 100 m²/g. For example, the specific surface area can be in a range of 6 m²/g to 60 m²/g, such as a range of 25 m²/g to 55 m²/g.

Nanoparticles can be formed using various methods. For example, nanoparticles can be formed using spray drying. In another example, the nanoparticles can be precipitated. In a further example, the nanoparticles can be fumed nanoparticles. In an additional example, the nanoparticles can be formed using a sol-gel process.

In a particular example, lithium can be sourced from recycled lithium ion batteries. Lithium oxides or lithium ceramics are used in lithium ion batteries and can be recovered to form lithium oxide particles useful in carbon dioxide capture.

In use, the nanoparticles can be disposed in a fixed bed or fluidized bed or can be used in a co-flow configuration. For example, FIG. 2 illustrates a fixed bed capture drum 202 that includes a fixed bed of nanoparticles 204. Carbon dioxide containing effluent gases 206 can flow through the fixed bed 204, providing a stream 208 having a reduced carbon dioxide content. The nanoparticles in the bed 204 can absorb the carbon dioxide undergoing a chemical change. Once a sufficient amount of the nanoparticles are converted, they can be recovered by facilitating the release of the carbon dioxide. For example, the nanoparticles in the fixed bed 204 can be exposed at a higher temperature (e.g. a temperature in a range of 400° C. to 900° C.) to a release gas containing oxygen. Alternatively or in addition, a voltage potential can be applied across the particles. The release gas can be used in smaller volumes and at lower flow rates than the effluent gas to ensure higher concentrations of carbon dioxide in the processed release gas.

In another example illustrated in FIG. 3, a fluidized bed can be utilized. For example, a drum 302 can incorporate a fluidized bed 304, through which a carbon dioxide rich effluent gas 306 flows. Processed effluent gases including reduced carbon dioxide content can flow through the exit stream 308. Optionally, the bed can be regenerated continuously. For example, used nanoparticles can flow through the outlet 310 into a regenerator 312. A high temperature oxygen-containing release gas 316 can co-flow with the particles through the regenerator 312. The particles can then be deposited back into the fluidized bed through return 314, while the carbon dioxide containing recovery gas 318 is sent to be sequestered.

Depending on the nature of the nanoparticles, the release gases can include oxygen and an inert gas such as nitrogen or argon. In further example, superheated steam enhanced with oxygen can be applied to the nanoparticles to recover carbon dioxide.

In a further example, illustrated in FIG. 4, the particles can be disposed in a co-flow arrangement such as a loop 402. For example, the nanoparticles can flow with the flow of the carbon dioxide rich effluent stream 404 applied into the loop 402. The temperature can be in a range of 25° C. to 600° C. Portions of the effluent stream can be released at 404 carrying some of the particles out of the loop 402. The particles can be recovered, for example, in a filter or a vortex 406 and sent to a regenerator 408. Regenerated nanoparticles can be applied back into the loop 402 at return 410. The cleaned effluent gas can be released from the vortex 406 at exit 412, and the recovered carbon dioxide can be released for sequester at recovery 414.

In the regenerator 408, the nanoparticles can be recovered, facilitating the conversion of the metal carbonate to metal oxide or hydroxide by exposing the nanoparticles to higher temperatures (e.g., a temperature in a range of 400° C. to 900° C.) and oxygen-containing atmosphere. For example, the nanoparticles may be exposed to an oxygen-containing atmosphere including an inert gas. In another example, the nanoparticles can be exposed to superheated steam including oxygen.

In an alternative example, the nanoparticles can be suspending an a solution. For example, the solution can include a solvent, such as an alcohol, for example, methanol, or an amine, such as monoethanolamine. In another example, the solution can be an aqueous solution or a mix of water and solvent.

The reversible reaction Li₂O+CO₂↔Li₂CO₃ has several advantages including:
Nano particles of Li₂O provide faster reaction kinetics;
Large surface area due to nano size particles of Li₂O;
Process relies on surface reaction only—allows for low energy desorption;
Repurpose spent Li₂O from all Li battery wastes including electric cars; and
Regeneration, and recycling of feedstock Li₂O provides for low-cost process.

### Example 1

Preliminary experiments have shown excellent capture data.

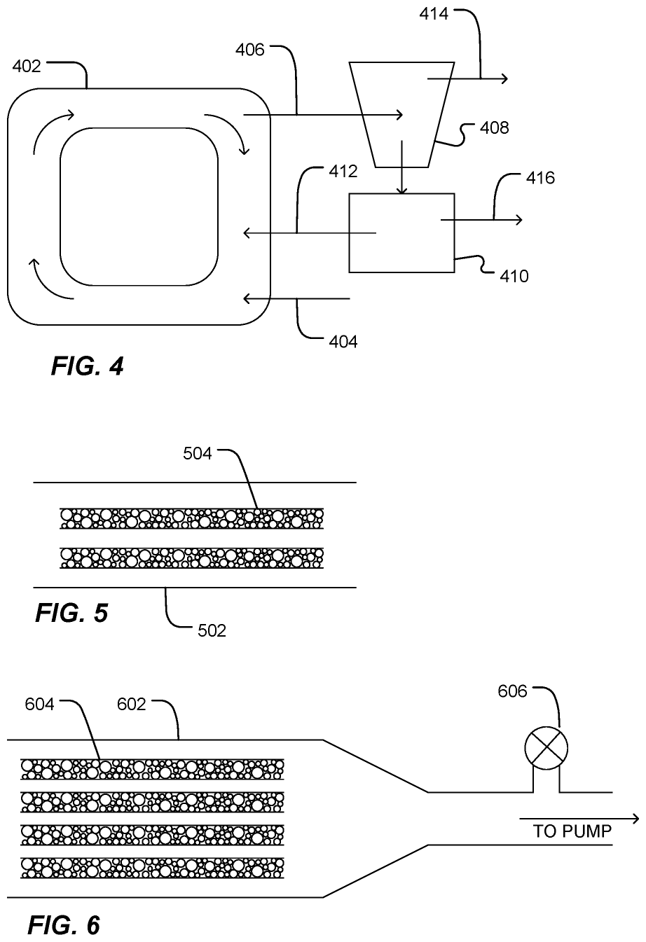

A bundle 502 (or larger tube) of glass tubes 504 is each filled with nano particles of Li₂O (FIG. 5). A gas stream containing CO₂ flows through the tubes in the bundle where CO₂ is selectively captured at room temperature. Xray Photoelectron Spectroscopy (XPS) of the particles indicates the presence of LiCO3 on the surface of the particles. A Fourier Transform Infra-Red (FTIR) spectrometer follows the concentration of carbonate and indicates when the Li₂O surfaces are saturated. At saturation, the gas flow is stopped, and the surfaces of the glass bundles are heated (in a range of 600° C. to 700° C.) with a heating jacket to release the CO₂, and pure CO₂ is collected under low pressure (e.g., roughing pump) downstream.

The source of CO₂ may be a concentrated source such as the flu gas from a coal fired power plant, petrochemical operations, or a cement factory. The versatility of this process also allows for direct air capture (DAC) of CO₂ from air. In the case of DAC, a pump is fitted to the bundle 602 and air is pulled through the glass tubes 604 (FIG. 6), similar to an air sampler used to monitor VOCs (Volatile Organic compounds) or AMC (Airborne Molecular Contamination). A flow meter 606 monitors flow rates.

Such nanoparticles systems are efficient in capturing carbon dioxide from various effluent streams including carbon dioxide in amounts from 0.5% to 80%. It has also been found that the system finds particular use in effluent strains containing 0.5% to 18% carbon dioxide. In view of the global goal of reducing carbon dioxide emissions to net zero, the present system finds particular use in reducing the amount of carbon dioxide in effluent streams to below the 0.05%, closer to the approximate amount of carbon dioxide currently in the atmosphere.

In a first aspect, a method for capturing carbon dioxide includes exposing nanoparticles to a carbon dioxide containing gas, the nanoparticles comprise alkali metal oxide, the alkali metal oxide changing to alkali metal carbonate, the nanoparticles having an average particle size in a range of 10 nm to 1000 nm; and heating the nanoparticles containing alkali metal carbonate to a temperature in a range of 400° C. to 900° C. to release carbon dioxide and recover the nanoparticles containing alkali metal oxide.

In an example of the first aspect, the alkali metal oxide is lithium oxide.

In another example of the first aspect and the above examples, the average particle size is in a range of 10 nm to 500 nm. For example, the average particle size is in a range of 10 nm to 100 nm. In an example, the average particle size is in a range of 15 nm to 45 nm.

In a further example of the first aspect and the above examples, the nanoparticles have a specific surface area in a range of 5 m²/g to 100 m²/g. For example, the specific surface area is in a range of 6 m²/g to 60 m²/g. In an example, the specific surface area is in a range of 25 m²/g to 55 m²/g.

In an additional example of the first aspect and the above examples, the temperature is in a range of 500° C. to 800° C. For example, the temperature is in a range of 600° C. to 700° C.

In another example of the first aspect and the above examples, exposing the nanoparticles to the carbon dioxide containing gas occurs at a temperature is in a range of 25° C. to 600° C. For example, exposing the nanoparticles occurs at a temperature is in a range of 25° C. to 400° C. In an example, exposing the nanoparticles occurs at a temperature is in a range of 25° C. to 250° C. In another example, exposing the nanoparticles occurs at a temperature is in a range of 25° C. to 100° C.

In a further example of the first aspect and the above examples, the method further includes the nanoparticles to a voltage potential in a range of 3V to 100V during heating. For example, the voltage potential is in a range of 3V to 50V.

In an additional example of the first aspect and the above examples, the nanoparticles have a core shell structure. For example, the shell of the core shell structure includes lithium oxide. In another example, the core of the core shell structure includes silica, aluminosilicate, alumina, titania, or lithium silicide.

In another example of the first aspect and the above examples, the nanoparticle is free of lanthanide or actinide metals or metal oxides.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method for capturing carbon dioxide comprises:
exposing nanoparticles to a carbon dioxide containing gas, the nanoparticles comprise alkali metal oxide, the alkali metal oxide changing to alkali metal carbonate, the nanoparticles having an average particle size in a range of 10 nm to 1000 nm; and
heating the nanoparticles containing alkali metal carbonate to a temperature in a range of 400° C. to 900° C. to release carbon dioxide and recover the nanoparticles containing alkali metal oxide.

2. The method of claim 1, wherein the alkali metal oxide is lithium oxide.

3. The method of claim 1, wherein the average particle size is in a range of 10 nm to 500 nm.

4. The method of claim 3, wherein the average particle size is in a range of 10 nm to 100 nm.

5. The method of claim 4, wherein the average particle size is in a range of 15 nm to 45 nm.

6. The method of claim 1, wherein the nanoparticles have a specific surface area in a range of 5 m²/g to 100 m²/g.

7. The method of claim 6, wherein the specific surface area is in a range of 6 m²/g to 60 m²/g.

8. The method of claim 7, wherein the specific surface area is in a range of 25 m²/g to 55 m²/g.

9. The method of claim 1, wherein the temperature is in a range of 500° C. to 800° C.

10. The method of claim 9, wherein the temperature is in a range of 600° C. to 700° C.

11. The method of claim 1, wherein exposing the nanoparticles to the carbon dioxide containing gas occurs at a temperature is in a range of 25° C. to 600° C.

12. The method of claim 1, wherein exposing the nanoparticles occurs at a temperature is in a range of 25° C. to 400° C.

13. The method of claim 1, wherein exposing the nanoparticles occurs at a temperature is in a range of 25° C. to 250° C.

14. The method of claim 1, wherein exposing the nanoparticles occurs at a temperature is in a range of 25° C. to 100° C.

15. The method of claim 1, further comprising the nanoparticles to a voltage potential in a range of 3V to 100V during heating.

16. The method of claim 15, wherein the voltage potential is in a range of 3V to 50V.

17. The method of claim 1, wherein nanoparticles have a core shell structure.

18. The method of claim 17, wherein the shell of the core shell structure includes lithium oxide.

19. The method of claim 17, wherein the core of the core shell structure includes silica, aluminosilicate, alumina, titania, or lithium silicide.

20. The method of claim 1, wherein the nanoparticle is free of lanthanide or actinide metals or metal oxides.
